(19) United States
(12) Patent Application Publication
(10) Pub. No.: US 2024/0055951 A1
(43) Pub. Date: Feb. 15, 2024

(54) INDUCTION ROTOR WITH END RING COOLING FEATURES

(71) Applicant: BorgWarner Inc., Auburn Hills, MI (US)

(72) Inventor: Andrew Dragon, Fishers, IN (US)

(21) Appl. No.: 17/884,207

(22) Filed: Aug. 9, 2022

(51) Int. Cl. H02K 9/19; H02K 1/32

(52) U.S. Cl. CPC H02K 9/19; H02K 1/32

(57) ABSTRACT

An induction rotor for an electric machine includes a rotor shaft, a core having a plurality of axially extending conductive bars, and an end ring disposed at an end of the core and electrically connected to the plurality of conductive bars. The end ring includes a plurality of plates, the plurality of plates include a pair of adjacent plates defining a fluid passage therebetween, and the fluid passage is configured to circulate a cooling fluid through the end ring.

### BACKGROUND

An induction motor is an asynchronous electric machine powered by alternating current (AC), which provides power by inducing rotation of a rotor via electromagnetic induction. An induction motor may operate as a generator or traction motor. Rotors of induction motors conventionally include axial or skewed conductor bars in, for example, a squirrel cage.

Induction or asynchronous motors are used in a variety of application, and are increasingly being used in automotive applications (e.g., as drive motors). An induction motor utilized in an automotive or other system exhibits high speed rotation and generates high temperatures within the rotor itself, which can compromise mechanical and structural integrity. As such, cooling systems utilizing cooling fluid (e.g., air, water, oil, etc.) are incorporated into rotors and/or induction motors.

### SUMMARY

An induction rotor for an electric machine, in accordance with a non-limiting example, includes a rotor shaft, a core having a plurality of axially extending conductive bars, and an end ring disposed at an end of the core and electrically connected to the plurality of conductive bars.

The end ring includes a plurality of plates, the plurality of plates include a pair of adjacent plates defining a fluid passage therebetween, and the fluid passage is configured to circulate a cooling fluid through the end ring.

A method of manufacturing an inductive rotor of an electric machine, in accordance with a non-limiting example, includes constructing a core of an electric machine, the core having a plurality of axially extending conductive bars, mounting the core on a rotor shaft, and installing an end ring at an end of the core to electrically connect the end ring to the plurality of conductive bars. The installing includes mounting an axial array of a plurality of plates on the conductive bars, disposing a spacing device between a pair of adjacent plates to create a separation therebetween, mechanically attaching the plurality of adjacent plates to the conductive bars while the spacing device is disposed between the pair of adjacent plates, and removing the spacing device. The mechanical attachment maintains the separation, and the separation defines a fluid passage configured to circulate a cooling fluid through the end ring.

An electric machine, in accordance with a non-limiting example, includes a stator and a rotor, the rotor including a rotor shaft and a core having a plurality of axially extending conductive bars. The rotor further includes an end ring disposed at an end of the core and electrically connected to the plurality of conductive bars. The end ring includes a plurality of plates, the plurality of plates include a pair of adjacent plates defining a fluid passage therebetween, and the fluid passage is configured to circulate a cooling fluid through the end ring.

### BRIEF DESCRIPTION OF THE DRAWINGS

FIG. 1 depicts an induction rotor for an electric motor, which includes a cooling system, in accordance with an aspect of an exemplary embodiment;

FIG. 2 is a cross-sectional view of the induction rotor of FIG. 1;

FIG. 3 depicts a section of the rotor of FIG. 1 including an end ring that provides one or more passages for cooling fluid;

FIG. 4 is a flow diagram depicting a method of manufacturing an induction rotor, in accordance with an aspect of an exemplary embodiment; and

FIG. 5 depicts an example of a technique for securing end rings as part of the method of FIG. 4.

### DETAILED DESCRIPTION

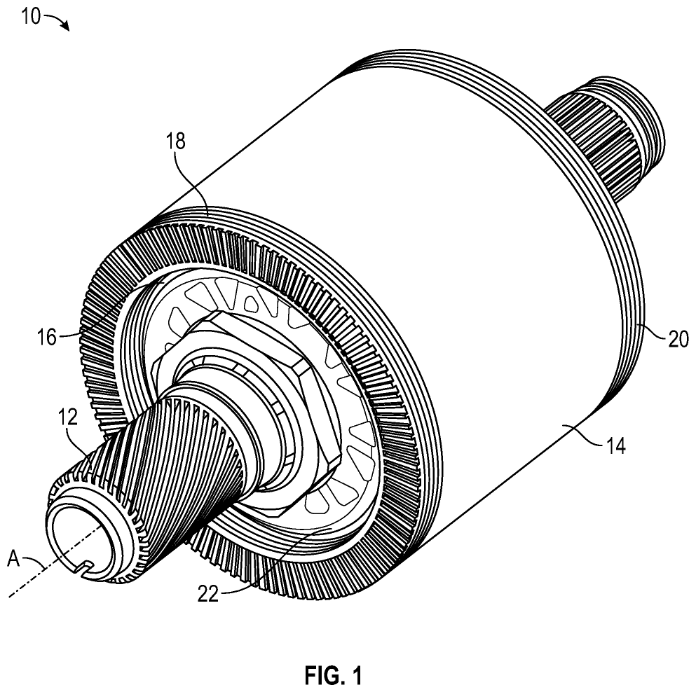

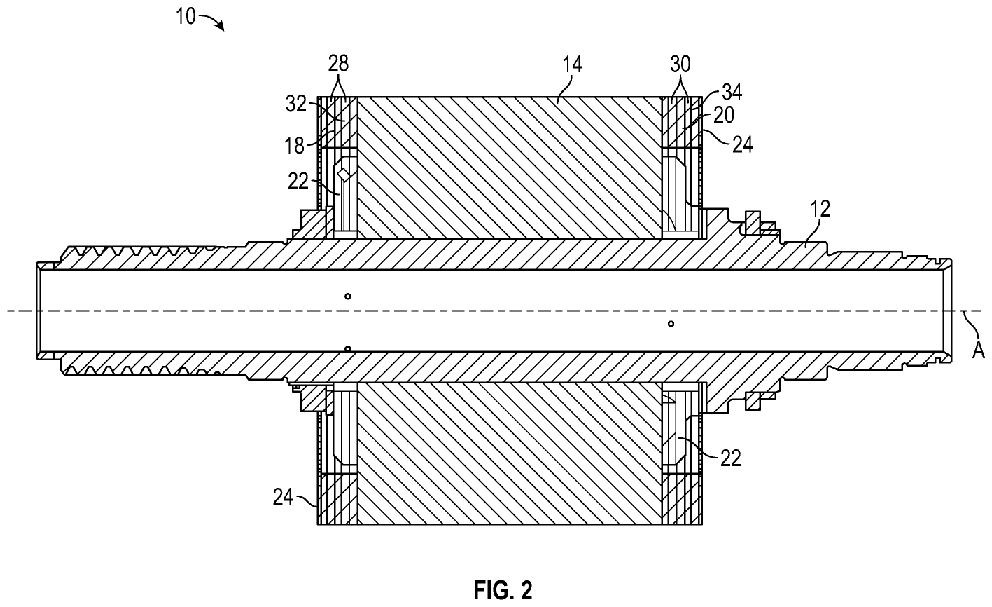

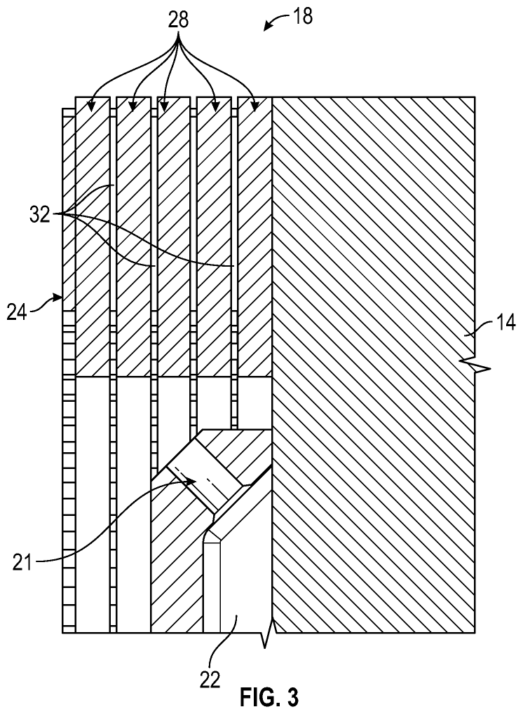

FIGS. 1-3 depict an embodiment of a rotor assembly 10 (“rotor”) for an electric machine. FIG. 1 is a perspective view of the rotor. FIGS. 2 and 3 are cross-sectional views in a plane that intersects a central rotational axis A of the rotor and is parallel to the rotational axis A.

The rotor 10 is an induction rotor that includes a central shaft 12 on which a rotor core 14 is mounted. The rotor core 14 includes a plurality of laminations 16 stacked in an axial direction (parallel to the rotational axis A), and a plurality of conductive bars 24 (shown in FIGS. 2 and 3) extending axially through the laminations. The rotor bars 24 are electrically connected to each other at the ends of the rotor core 14 by a first end ring 18 and a second end ring 20.

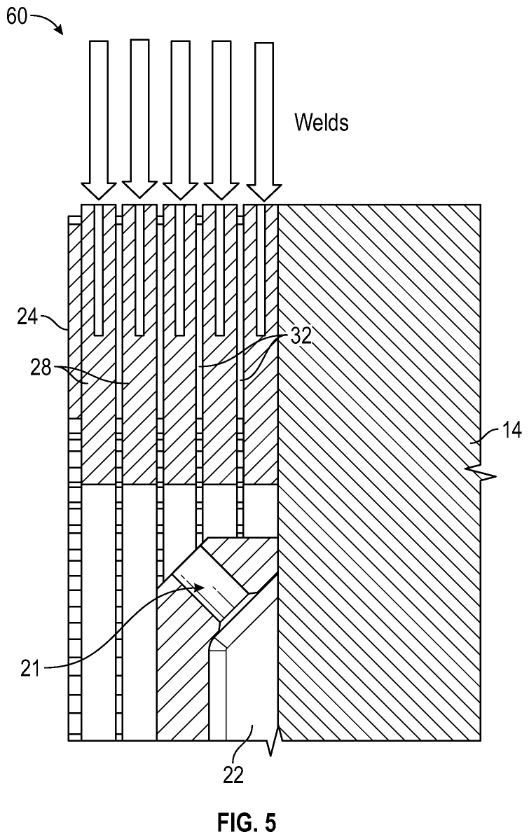

The rotor 10 may be cooled in various ways. In an embodiment, the rotor 10, when installed in a motor assembly, is connected to a cooling system. In an embodiment, the cooling system injects and/or circulates a cooling fluid (e.g., oil, water, air, etc.) through the rotor 10. For example, the cooling system is an oil-cooled system that injects oil 22 via one or more spray nozzles 21 (see FIGS. 3 and 5).

The end rings 18 and 20 are configured to facilitate convective cooling by maintaining one or more fluid passages within each end ring. The fluid passages are established by gaps or spaces between constituent plates of the end rings 18 and 20. For example, each passage is in fluid communication with oil 22 from the rotor 10 and provide a path to circulate the oil 22 between adjacent plates. The passages provide for an increased surface area for cooling as compared to conventional end rings and/or conventional rotors.

The conductive bars 24 extend through the end rings 18 and 20 and are attached to plates in each end ring via welds or other suitable attachment mechanism. Any suitable attachment that provides a mechanical and electrical connection may be used.

For example, each ring 18 and 20 includes a plurality of ring plates axially stacked together. The plates may be flat annular plates, each having a ring shape and openings to accommodate the conductive bars 24. As shown in FIGS. 2 and 3, the end ring 18 includes a plurality of axially arrayed plates 28, and the end ring 20 includes a plurality of axially arrayed plates 30.

In the end ring 18, the plates 28 are separated axially by spaces or gaps which form fluid passages 32 that are each in fluid communication with the oil 22 from the rotor core 14. Likewise, the plates 30 of the end ring 20 are separated from one another to form fluid passages 34. The fluid passages 32 and 34 provide for an increased surface area for the oil 22 to contact the plates 28 and 30, and thereby improve convective cooling of the end rings 18 and 20 and the core 14.

The fluid passages 32 and 34 may have any desired width, which corresponds to a separation between adjacent plates. The width(s) are selected based on, for example, space constraints, the thicknesses of the plates, fluid type and/or other considerations. For example, the passage width may be selected to have a desired ratio between plate thickness and passage width plate about 2.5 mm and gap 0.5-1 mm. The passages may all have the same width or have different widths.

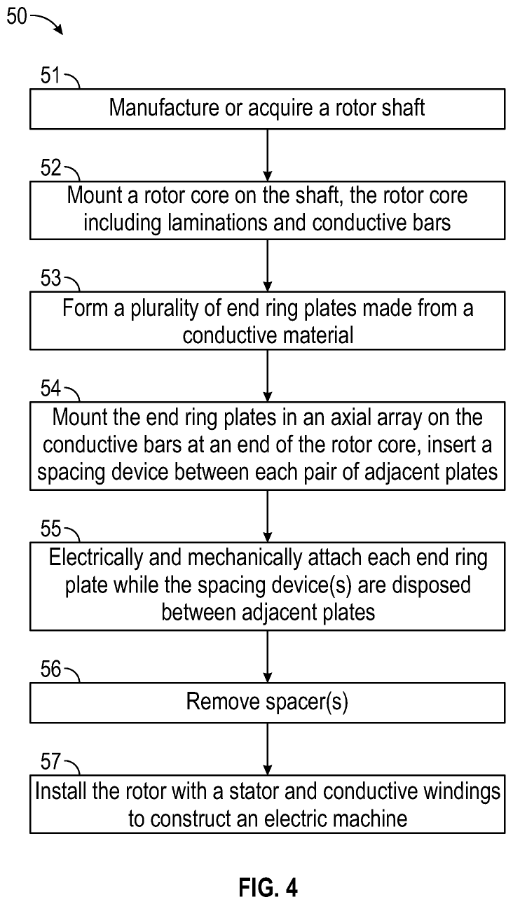

FIG. 4 illustrates embodiments of a method 50 of manufacturing a stator body and/or operating an electric machine, e.g., an inductive electric motor. The method 50 includes a number of steps or stages represented by blocks 51-57. The method 50 is not limited to the number or order of steps therein, as some steps represented by blocks 51-57 may be performed in a different order than that described below, or fewer than all of the steps may be performed.

At block 51, a rotor shaft is manufacturing or acquired. The rotor shaft may be configured for use as a drive shaft for a traction motor or generator.

At block 52, a rotor core, such as a squirrel cage rotor core, is mounted on the rotor shaft. The rotor core includes a stack of laminations and conductor bars in a squirrel cage configuration or other configuration.

At block 53, a plurality of end ring plates are formed from a conductive material (e.g., steel, copper or aluminum). The end ring plates may be formed using any suitable method, such as stamping, machining (e.g., computer numerical control or CNC, water jet machining, etc.), laser cutting and others. Each end ring plate may be a formed as a flat annular plate including slits for the conductor bars.

At block 54, the end ring plates are mounted on the conductor bars to form an axial array of plates along the conductive bars. The conductor bars are formed of a conductive material, such as aluminum or copper. For the highest performing motor, the conductive bars and end ring plates should be formed of a low resistance material, such as copper. A spacing device or body is inserted between each pair of adjacent end ring plates to establish a separation or gap between adjacent plates. In an embodiment, one or more tooling spacers or other spacing devices having a width corresponding to the desired width of fluid passages are inserted at various locations to maintain a consistent gap between the entirety of each pair of adjacent plates.

At block 55, the end ring plates are attached to the conductor bars to establish a mechanical and electrical connection between the plates and the conductor bars. The end ring plates can be attached using any desired attachment technique, such as welding. In an embodiment, each plate is attached via center welding, in which a weld (e.g., a laser weld) is formed in an interior of each plate.

At block 56, the spacing device or devices are removed, and the weld or other mechanical attachment maintains the separation. The separation defines one or more fluid passages between adjacent

In an embodiment, blocks 53-56 are performed for a first end ring at one end of the rotor core, and repeated for a second end ring at an opposing end of the core.

At block 57, the rotor is installed with a stator having conductor windings, and other suitable components to construct an induction motor assembly. The induction motor assembly may then be installed in a vehicle or other system and operated accordingly. During operation, cooling fluid such as oil is circulated in the rotor to cool the rotor. The cooling fluid flows through the passages defined by the end rings.

FIG. 5 depicts an example of an attachment between the plates and the conductive bars. The attachment includes a center weld 60 formed in an interior of each plate 28. The center welds 60 provide a mechanical and electrical connection to the conductive bars 24. The center welds 60 permit the end ring 18 to maintain the fluid passages 32 and provide more surface area than would be achievable using other methods. For example, end ring plates are typically stacked together and welded at the seams between each plate. The center welds 60 provide for fluid passage space that is not achievable using such a typical process. It is noted that embodiments described herein are no limited to center welds or internal welds, as any suitable attachment mechanism may be employed that provides a mechanical and electrical connection and maintains spacings for fluid passages.

Embodiments described herein present a number of advantages and technical effects. For example, the fluid passages provide for an increased surface area that contacts a cooling fluid, thereby improving thermal management capability of a rotor cooling system. In addition, the manufacturing methods described herein permit the establishment of cooling passages by using center welds or other suitable attachment mechanisms. For example, the embodiments described herein provide for 3 to 10 times more surface area of the end rings available for convective cooling as compared to conventional or current rotors.

The terms “about” and “substantially” are intended to include the degree of error associated with measurement of the particular quantity based upon the equipment available at the time of filing the application. For example, “about” and/or “substantially” can include a range of ±8% or 5%, or 2% of a given value.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. An induction rotor for an electric machine, comprising:
a rotor shaft;
a core having a plurality of axially extending conductive bars; and
an end ring disposed at an end of the core and electrically connected to the plurality of conductive bars, the end ring including a plurality of plates, the plurality of plates including a pair of adjacent plates defining a fluid passage therebetween, the fluid passage configured to circulate a cooling fluid through the end ring.

2. The rotor of claim 1, wherein the cooling fluid includes oil circulated through the core.

3. The rotor of claim 1, wherein each plate is a flat annular plate, and the plurality of plates are arrayed axially along the plurality of conductive bars.

4. The rotor of claim 1, wherein the plurality of plates include a plurality of pairs of adjacent plates defining a plurality of fluid passages through the end ring.

5. The rotor of claim 1, wherein the end ring includes a first end ring at a first end of the core and a second end ring at a second end of the core.

6. The rotor of claim 5, wherein the first end ring includes a plurality of first plates defining a first fluid passage, and the second end ring includes a plurality of second plates defining a second fluid passage.

7. The rotor of claim 1, wherein each plate is mechanically attached to the plurality of bars via a weld.

8. The rotor of claim 7, wherein each weld is internal to a respective plate.

9. The rotor of claim 1, wherein the conductive bars and the plurality of plates are formed from copper.

10. A method of manufacturing an inductive rotor of an electric machine, comprising:
constructing a core of an electric machine, the core having a plurality of axially extending conductive bars;
mounting the core on a rotor shaft; and
installing an end ring at an end of the core to electrically connect the end ring to the plurality of conductive bars, wherein the installing includes:
mounting an axial array of a plurality of plates on the conductive bars;
disposing a spacing device between a pair of adjacent plates to create a separation therebetween;
mechanically attaching the plurality of adjacent plates to the conductive bars while the spacing device is disposed between the pair of adjacent plates; and
removing the spacing device, wherein the mechanical attachment maintains the separation, the separation defining a fluid passage configured to circulate a cooling fluid through the end ring.

11. The method of claim 10, wherein each plate is a flat annular plate, and the plurality of plates are arrayed axially along the plurality of conductive bars.

12. The method of claim 10, wherein the end ring includes a first end ring at a first end of the core and a second end ring at a second end of the core, and the method includes mechanically attaching a plurality of first plates to define a first fluid passage, and mechanically attaching a plurality of second plates to define a second fluid passage.

13. The method of claim 10, wherein each plate is mechanically attached to the plurality of bars via a weld.

14. The method of claim 13, wherein each weld is internal to a respective plate.

15. An electric machine comprising:
a stator and a rotor, the rotor including a rotor shaft and a core having a plurality of axially extending conductive bars, the rotor further including:
an end ring disposed at an end of the core and electrically connected to the plurality of conductive bars, the end ring including a plurality of plates, the plurality of plates including a pair of adjacent plates defining a fluid passage therebetween, the fluid passage configured to circulate a cooling fluid through the end ring.

16. The electric machine of claim 15, wherein each plate is a flat annular plate, and the plurality of plates are arrayed axially along the plurality of conductive bars.

17. The electric machine of claim 15, wherein the plurality of plates include a plurality of pairs of adjacent plates defining a plurality of fluid passages.

18. The electric machine of claim 15, wherein the end ring includes a first end ring at a first end of the core and a second end ring at a second end of the core.

19. The electric machine of claim 18, wherein the first end ring includes a plurality of first plates defining a first fluid passage, and the second end ring includes a plurality of second plates defining a second fluid passage.

20. The electric machine of claim 15, wherein each plate is mechanically attached to the plurality of bars via a weld.
